(19) United States
(12) Patent Application Publication
(10) Pub. No.: US 2009/0053011 A1
(43) Pub. Date: Feb. 26, 2009

(54) Invisible staple a transparent plastic staple

(76) Inventor: Jesica Beth Brackett, Marblehead, MA (US)

Correspondence Address: Jesica Brackett, 20 Darling Street, Marblehead, MA, 01945-3535, US

(21) Appl. No.: 11/975,940

(22) Filed: Oct. 23, 2007

Related U.S. Application Data
(60) Provisional application No. 60/965,663, filed on Aug. 21, 2007.

(51) Int. Cl. F16B 15/00

(52) U.S. Cl. 411/457

(57) ABSTRACT

The present invention will revolutionize the way consumers look at staples, literally. The clear transparent plastic staple, also referred to as the Invisible Staple, staple and staple strip, is made of a clear plastic material therefore admits light without appreciable diffusion or distortion so that objects and colors beyond or directly under the staple are visible.

This application claims priority to Provisional Patent Application Ser. No. 60/965,663, filed Aug. 21, 2007 as priority.

Disclosure Document No. 593914, filed Jan. 30, 2006.

### BACKGROUND OF THE INVENTION

1. Field of the Invention

The present invention relates to the staple and staple strip and more particularly, to plastic staples and plastic staple strips.

2. Description of Related Art

Others have invented wire staples and staple strips to be driven into material to be stapled and/or to hold material to a work area but as these staples are metal and appears silver/gray in color, when bound to papers and the like or pressed onto bulletin boards to hold papers and the like the wire staple holds its color and can distracts from the materials bound and be esthetically displeasing.

As these staples are made of metal, when discarded incorrectly and left on the ground it can be hazardous if stepped on or ingested by a child, adult or animal.

As these staples are metal, when attached to documents being shredded the metal staple may damage the shredder machine blades.

As these staples are metal, they weigh more then my plastic made staple and therefore cost more to ship.

As these staples are metal, they may cost more in raw materials to manufacture, making the present invention more cost-effective.

In view of the above points as well as any other advantages a skilled eye in the art would recognize my inventions is unique, superior and novel. The transparent plastic material used has similar strength and durability as said wire staple.

Prior art has barbs on the legs of the staple to fasten and hold material such as cellular or foam plastic, corrugated cardboard, and if used on, would damage bulletin boards and the like when removing the barbed staple legs. And unlike prior art, the present invention does not rely on an elastic memory plastic to hold material in place.

The present invention, the clear plastic staple, is also unique and novel because the transparent plastic staple and staple strip are made to fit and operate in a standard stapler such as but not limited to office staplers, hand-held stapler, and desktop stapler, staple guns, as well as any future inventions claiming to be a stapler or the like, that are made to specifications required by the staple and stapler manufacturers. The said plastic staple and staple strip may or may not be manufactured in the same or in a similar way as the wire staple using the same or a similar process of making its ware by machinery.

The present invention, unlike prior art, is unique and novel because it is made of a clear plastic material that hold its preformed original shape FIG. 1 and may or may not be cold-bent to securely hold the bent position FIG. 5(a) and FIG. 6. My invention is made of a clear plastic material therefore admits light without appreciable diffusion or distortion so that objects and colors beyond or directly under the said plastic staple are visible making my invention unique.

The present invention, the clear plastic staple, is novel because it will revolutionize the way consumers look at staples, literally.

My invention holds three standardized positions FIG. 1 and FIG. 5(a) and FIG. 6 and is made of a different material and each position holds unique attributes therefore FIG. 1 should be viewed as individual and separate claims from FIG. 5(a) and FIG. 6.

### SUMMARY OF THE INVENTION

Accordingly, it is the principle objective of the present invention to provide a novel clear plastic staple. The said clear plastic material used has similar strength and durability as related prior art but is unique and novel in that it is made of said clear plastic material and appears virtually see-through, taking on whatever color and/or pattern it holds to. The present invention is suitable to fit and work in standard staplers, but not limited to such devices. The said staple has two parallel legs and a crown integrally joining the said legs. The free portions of the said legs have pointed tips to assist penetration when the said staple is driven through the said stapler. When the said stapler is used in the open position, not using the anvil, the said staple holds said material and the like to a predetermined work area. After engagement the said staple holds its preformed original shape. For the purpose of binding said materials and the like the said staple is forced out of the said stapler by way of hand force or automatic electric power force and the like, encountering the said stapler's anvil at which point the said legs are cold-bent to hold the bent position based on the direction of the said stapler's anvil.

### BRIEF DESCRIPTION OF DRAWINGS

FIG. 1 is an enlarged side view, respectively, of one embodiment of the present invention;

FIG. 2 is an enlarged fragmentary view of a strip of plastic staples made up of a predetermined number of the plastic staple of FIG. 1;

FIG. 3(a) is an enlarged fragmentary cross-sectional view showing the completed installation of the plastic staple of FIG. 1;

FIG. 3(b) is an enlarged fragmentary cross-sectional top view after installation of the plastic staple of FIG. 1;

FIG. 4 is a perspective view of an existing stapler in the open position, and position achieves FIG. 3(a)-FIG. 3(b) after installation of the plastic staple FIG. 1;

FIG. 5(a) is an enlarged side view, respectively, of one embodiment of a plastic staple;

FIG. 5(b) is an enlarged fragmentary cross-sectional top view showing the completed instillation of the plastic staple of FIG. 1;

FIG. 5(c) is an enlarged fragmentary cross-sectional bottom view showing the completed instillation of the plastic staple of FIG. 1; and

FIG. 6 is an enlarged side view, respectively, of one embodiment.

### DETAILED DESCRIPTION OF THE PREFERRED EMBODIMENTS

FIG. 1 illustrates one embodiment of a plastic staple well suited for maintaining or fastening a piece of paper or the like to a bulletin board or the like in accordance with the teaching of the present invention; having a pair of legs 32 and a crown 30 joining the legs at their upper ends in a parallel position. The free ends of the legs 32 show the pointed tips 36, or the like, for penetrating material to the work area during the driving of the staple.

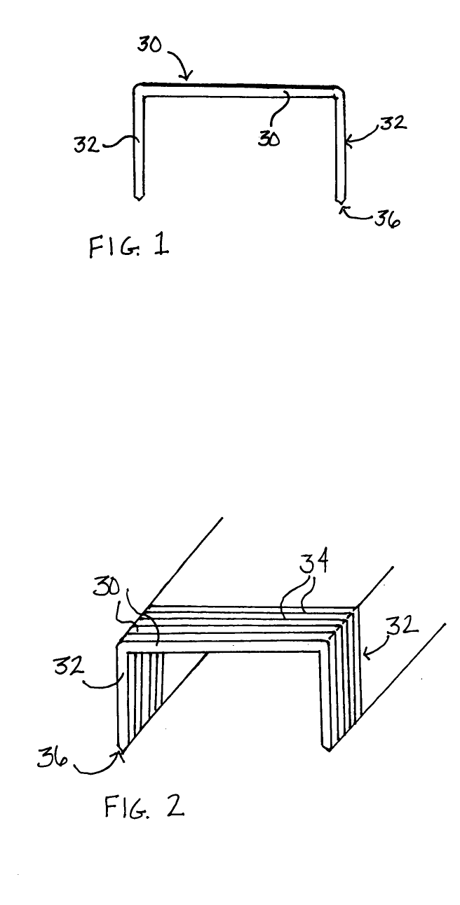

The strip of staples shown in FIG. 2 is made up of a predetermined number of the plastic staple in FIG. 1 held together with an adhesive 34 or the like or manufactured by injection molding or the like. The legs 32 and the crown 30 are attached to another staple creating the strip.

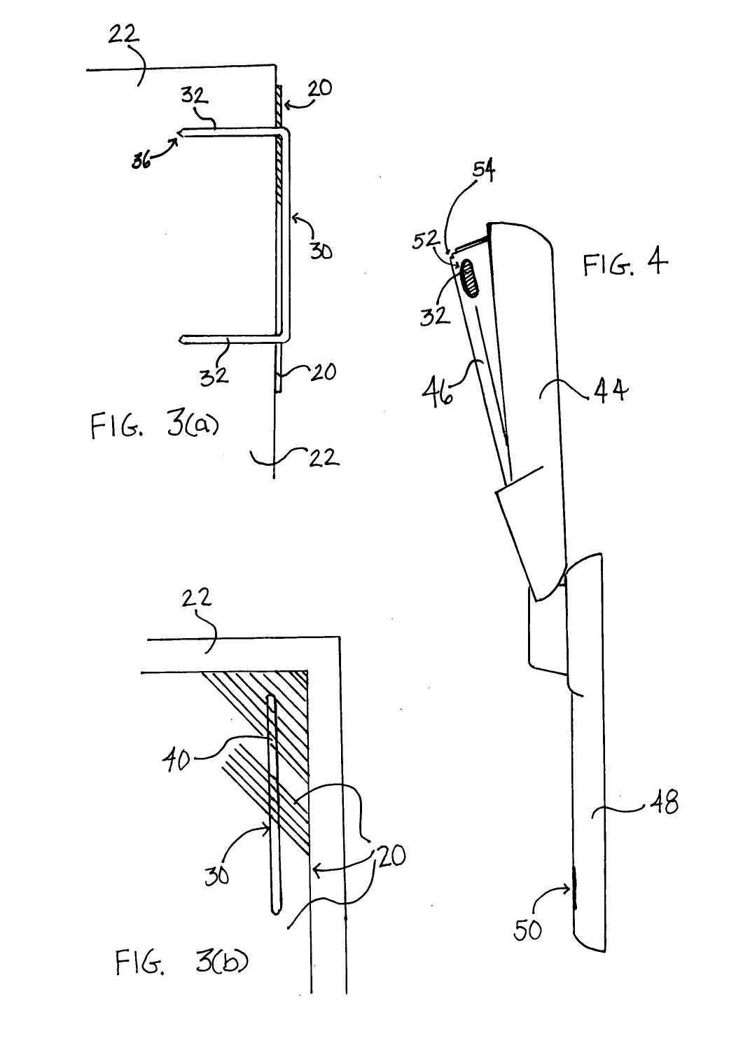

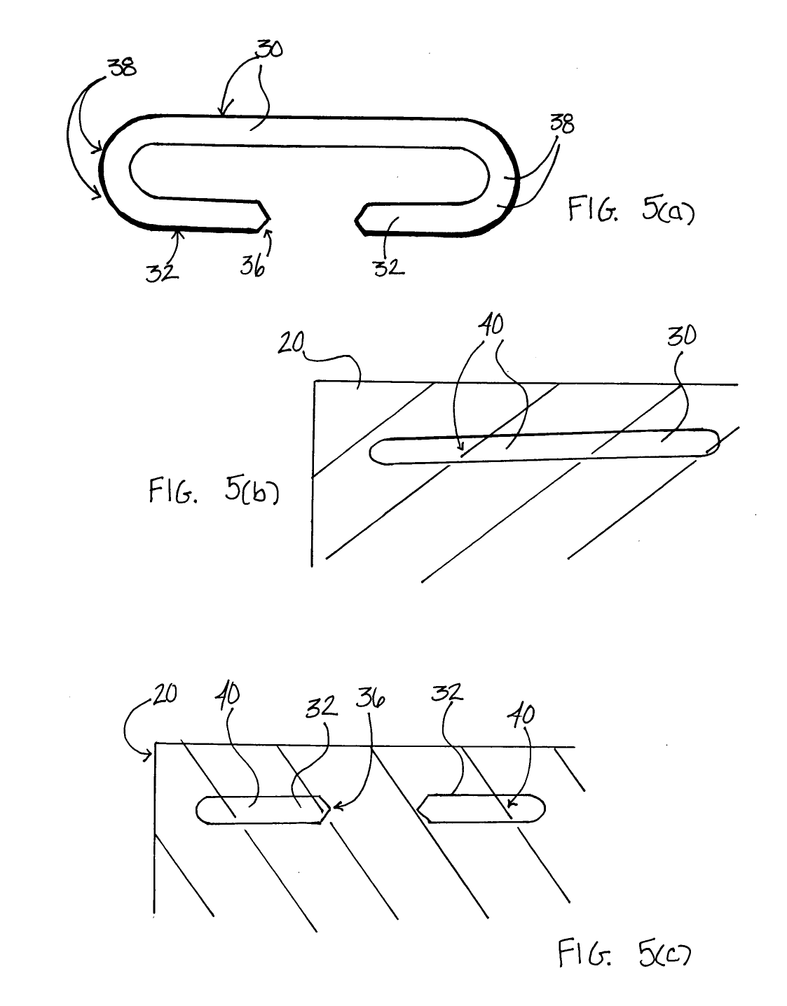

FIG. 3(a) illustrates the completed installation of the plastic staple of FIG. 1 using the staplers open place setting seen in FIG. 4. After the free portion of the legs 32 with the pointed tips 36 have penetrated and fastened material, in this case a sheet of paper 20 to the work area, in this case a bulletin board 22. Engagement has occurred after pressure has been applied to the stapler's head FIGS. 4, 44. After the legs 32 have been driven into the work area 22 only the crown 30 remains visible.

FIG. 3(b) shows the exposed staple crown 30 and the transparent quality 40 of the present invention after instillation is completed, in this case exposing a sheet of paper 20 or the like directly under the plastic staple FIG. 1 that is holding to the work area, in this case a bulletin board 22 or the like.

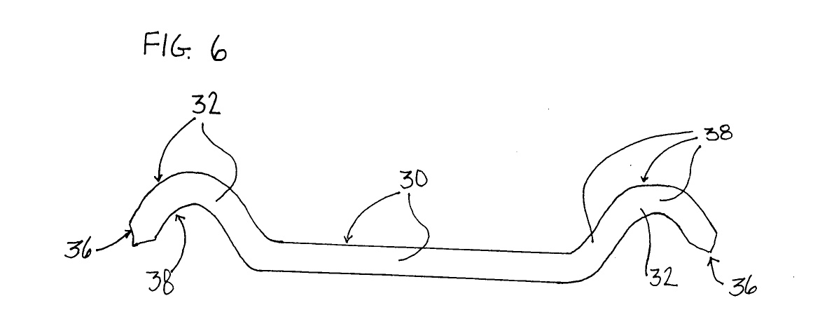

FIG. 4 illustrates an existing stapler with which staples of the present invention may be used, it being understood that other models, or future models, of stapling tools may also be used. The stapler demonstrates the open place setting needed to complete installation of the plastic staple in FIG. 1 to achieve FIG. 3(a) and FIG. 3(b) showing the exposed staple crown 30 and the unique transparent quality 40 of the present invention, in this case the piece of paper 20 or the like under the plastic staple crown 30 that is holding to the working area, in this case a bulletin board 22 or the like. The existing stapler exposes one of a pair of legs 32 attached to a crown 30 in strip form seen in FIG. 2 through a an oval shaped hole 52. The staple strip seen in FIG. 2 fits and is housed in the chamber 46 of a stapler before it is driven through. On the base 48 of the stapler is the staple anvil 50 which determines the direction that the pair of staple legs 32 will be cold-bent to hold the position seen in FIG. 5(a) and FIG. 6. This occurs when the stapler is in its ordinary position (not seen in figures) and force is applied by way of hand or automatic electric power force or the like to the head 44 of the stapler.

FIG. 5(a) another embodiment of the present invention illustrating the present invention after the pair of legs 32 have been pressed through the opening 54 of the existing stapler and have penetrated the material being stapled, in this case a sheet of paper 20. During the stapling process the legs 32 engage the stapler's anvil 50 and are cold-bent 38 to hold the position predetermined by the anvil 50.

FIG. 5(b) and FIG. 5(c) illustrate the unique transparent quality 40 of the present invention. FIG. 5(b) shows the top view of the exposed staple crown 30, demonstrating how the material, in this case a sheet of paper 20, directly under the crown 30 is visible after the staple in FIG. 1 has been through the stapling process, completing installation. FIG. 5(c) shows the bottom view of the material, in this case a sheet of paper 20, after it has been through the stapling process at which time the free legs 32 with the pointed tips 36 of the staple FIG. 1 have been cold-bent 38 to hold their position predetermined by the stapler's anvil 50. The exposed free legs 32 demonstrate the transparent quality 40 of the present invention exposing the material, in this case a sheet of paper 20 or the like under the free legs 32.

FIG. 6 another embodiment of the present invention illustrating the plastic staple FIG. 1 after it has been through the stapling process and the legs 32 are cold-bent 38 to hold their position predetermined by the stapler's anvil 50.

The present invention holds three standardized positions FIG. 1 and FIG. 5(a) and FIG. 6 and is made out of a different material and each position holds unique attributes therefore FIG. 1 should be viewed as individual and separate claims from FIG. 5(a) and FIG. 6.

An embodiment of the present invention is explained based on the description of drawings with particular references to specific embodiments, but the present invention's scope and attributes are not limited to the embodiment. Thereof it should be understood that other modifications, future plastics, future materials, future staplers, future staple sizes, other non-mentioned work areas and other advantages a skilled eye in the art would recognize fall under the scope of the present invention as defined in the appending claims.

What I claim as my invention is:

1. A staple formed from a clear transparent plastic material that holds its preformed original shape, made to the specifications required by staple and stapler manufacturers, and adapted to be driven by a stapler or the like, in the open position not using the said stapler's anvil for use in fastening material such as paper, photographs, and the like, onto a work area such as bulletin boards, cork boards, plaster walls, and the like, said staple comprising:
a pair of preformed, straight parallel legs; and
a preformed straight crown connecting said legs portion so that the legs are parallel at an angle of 90 degrees or as close to 90 degrees;
each of the said leg portions free from the said crown are defined by a sharp point such as blunt point tips, divergent point tips, chisel point tips, or the like, designed to penetrate said material to a said work area during the driving of the staple.

2. A staple formed from a clear transparent plastic material that can be cold-bent, driven by a said stapler in a predetermined direction based on the said stapler's anvil for use in binding materials such as paper, photographs, and the like, said staple comprising:
a pair of preformed, straight parallel legs; and
a preformed straight crown connecting said legs portion so that the legs are parallel at an angle of 90 degrees or as close to 90 degrees;
each of the said leg portions free from the said crown are defined by a sharp point such as blunt point tips, divergent point tips, chisel point tips, or the like, designed to penetrate said material during the binding process.

3. The staple in claim 1 and 2 further characterized in the plurality of said staples are provided in the form of a predetermined number to make a full strip, the length of said full strip fits into standard staplers, other stapling devices and the like as well as any future inventions claiming to be a stapler or the like.

4. The staple in claim 1 and 2 further characterized in that the said staple strip is held together using an adhesive or the like or manufactured by injection molding or the like.

5. The staple in claim 1 and 2 further characterized in that said staple and said staple strip are manufactured for standard staplers using a similar process of making its ware by machinery; only the said plastic staple is made using a clear plastic material that hold its preformed original shape and may or may not be cold-bent to hold the bent position; the said plastic material are such as but not limited to polymeric wire, semicrystalline polymer, glycolide-rich blend of polymers, polycarbon, lexan polycarbonate, nylon, acrylic, polyethylene, polyvinyl chloride (PVC), acetal and/or delrin, polyurethane, as well as other future materials and combination of materials including non-plastic materials claiming to hold the same or similar characteristics as the present invention.

6. The staple in claim 1 and 2 further characterized in that the said staple is made out of said clear plastic material but not limited to a clear, in addition, the said material used may have a colored tint or hue enhanced tone or the like.

7. The staple in claim 1 and 2 further characterized in that it differs from prior art and is novel because of it is made out of said clear plastic material and has a transparent appearance.
